(19) United States
(12) Patent Application Publication
(10) Pub. No.: US 2013/0224039 A1
(43) Pub. Date: Aug. 29, 2013

(54) Rotor for Vertical Wind Power Station

(71) Applicant: Josef Moser, Erding (DE)

(72) Inventor: Josef Moser, Erding (DE)

(21) Appl. No.: 13/441,677

(22) Filed: Apr. 6, 2012

(30) Foreign Application Priority Data
Feb. 29, 2012 (DE) 10 2012 203 138.3

(51) Int. Cl. F03D 3/06

(52) U.S. Cl. 416/242

(57) ABSTRACT

The present invention relates to a rotor for a vertical wind power station comprising a plurality of planar rotor elements (2A, 2B, 2C) that are arranged around a hub region (3), wherein the rotor elements (2A, 2B, 2C) have a helical axis which is parallel or inclined relative to an axis of rotation (4) of the rotor (1) and around which the rotor elements (2A, 2B, 2C) are twisted in a spiraling manner, the rotor elements (2A, 2B, 2C) having concave and convex surface regions smoothly merging into each other and having different radii of curvature along the helical axis.

### PRIORITY CLAIM

This application is a United States Non-provisional Application claiming priority under 35 U.S.C. §119 from German Patent Application No. DE 102012203138.3, filed Feb. 29, 2012, the entire contents of which are herein incorporated by reference.

### FIELD OF THE INVENTION

The present invention relates to a rotor for a vertical wind power station in comprising a plurality of planar rotor elements that are arranged around a hub region, characterized in that the rotor elements have a helical axis which is parallel or inclined relative to an axis of rotation of the rotor and around which the rotor elements are twisted in a spiraling manner, the rotor elements having concave and convex surface regions smoothly merging into each other and having different radii of curvature along the helical axis and further as demonstrated by FIG. 1.

### BACKGROUND OF THE INVENTION

A number of different rotor types for wind power stations have been described and tested in the prior art.

A basic distinction is made between so-called resistance rotors and so-called lift rotors.

Resistance rotors chiefly make use of the drag of their rotor elements. As a result of the stagnation pressure brought about by the deceleration of the wind flow on the windward side of the rotor element, a force urging the rotor element away from the wind acts on the surface area of the rotor element. This force is greatest when the rotor elements are stationary and becomes smaller with an increase in rotational speed of the rotor elements.

Such resistance rotors thus are genuine slow runners. In the prior art, various resistance rotors have been described, from three-blade wind turbines currently being used in commercial wind power stations to start with, to vertically arranged Savonius rotors having a helical configuration.

The resistance rotors described at the outset are contrasted by lift rotors. Lift rotors make use of the dynamic lift effect of an airfoil-type construction of their rotor elements. The flow along the rotor element, which is cambered as a general rule, results in the creation of a negative pressure on the front side of the rotor element and a slight positive pressure on the back side of the rotor element. Due to this pressure difference a force acts on the rotor element and ultimately drives the rotor.

This force attains its maximum once the rotor elements of a lift rotor have already been set in motion, with the optimum speed depending on the wind velocity and the profile shape of the rotor elements. However, a higher performance of a lift rotor in the upper speed range is offset by a conversely lower starting torque of the rotor at standstill. Large-sized lift rotors without adjustment of the rotor elements thus frequently require an auxiliary motor for startup.

As regards previously known forms of resistance rotors, the so-called Darrieus rotors have been described in the prior art.

These may be realized in the classical O-shape or “eggbeater design”, H-shape, and also in a helical shape.

What is equally known in the prior are so-called hybrid forms which seek to combine the advantages of resistance rotor and lift rotor manifesting at different wind speeds. In the case of such hybrid rotors, the high torques of the resistance rotor are made use of in the lower speed range, allowing as a general rule to do away with a starter motor, while the high torque of the lift rotor takes effect in the upper speed range. The prior art includes examples of using hybrid vertical rotors that are hybrid forms of the Darrieus and Savonius turbines.

Due to their constructional design and their physical operating principle, vertical-axis wind turbines—referred to in short as vertical rotors—present a number of advantages:

Yaw control equipment typically is not required as the wind may attack on the vertical rotor from any side from 0 to 360 degrees. Vertical rotors accordingly are also not sensitive to varying wind forces and wind directions.

Another advantage of vertical rotors resides in the fact that generator and gearbox may be arranged near the ground for easy access.

These advantages do, however, also have to be paid for through a number of drawbacks:

Thus, particularly resistance rotors give rise to low power coefficients, pulsating torques, possibly required auxiliary motors as a start-up aid for lift rotors. Owing to their particular suitability for wind power stations having relatively low power yields in the range from 1 to 10 kW, vertical rotors have hitherto not found acceptance yet for a utilization in power generation on an industrial scale.

In that field, horizontal-axis designs are presently used almost exclusively.

The applications for vertical rotors therefore lie predominantly in areas where only comparatively low power is needed and where the advantages of the rotor, in particular the relatively simple construction and the lack of sensitivity of the rotor, predominate. As wind generators for electricity generation, vertical rotors are employed for instance in the power supply for insular networks or insular stations, e.g. for charging accumulators or as wind energy heating. Another possibility is the use of vertical-axis rotors in order to mechanically drive pumping stations for irrigation and drainage.

One known example of a hybrid rotor is the SHPADI propeller according to EP 2 028 102 A1 which is constructed asymmetrically, with sabre-type wings involuted in the manner of a Moebius strip.

Up to the present, however, hybrid rotors such as the hybrid rotors of a Darrieus turbine and a Savonius turbine have in a global view been afflicted with considerable drawbacks, due in particular to the fact that the airflow is made turbulent as a result of the resistance and lift rotors that are commonly arranged separately from each other, thus resulting in the appearance of considerable performance losses as a major part of the forces from the airflow can not be utilized as a drive source for the rotor. This is the starting point of the invention.

### SUMMARY OF THE INVENTION

Starting out from the prior-art hybrid rotors of Darrieus and Savonius rotors, it accordingly is an objective of the present invention to provide an improved rotor for a vertical wind power station.

The present invention relates in particular to a rotor for a vertical wind power station comprising a plurality of planar rotor elements that are arranged around a hub region, with the rotor elements having a helical axis which is parallel or inclined relative to an axis of rotation of the rotor and around which the rotor elements are twisted in a spiralling manner, the rotor elements having concave and convex surface regions smoothly merging into each other and having different radii of curvature along the helical axis.

A rotor according to FIG. 1 also achieves this objective.

Owing to the construction of the rotor of the invention, the central region of the rotor acts as a resistance rotor, whereas the distal regions of the rotor elements create a lift to thus imbue the rotor with a hybrid character of resistance rotor and lift rotor.

One particular advantage of the rotor of the invention is founded in the fact that the spiraling movement of the airflows being passed through is optimized, with these airflows hardly, if at all, interfering with each other in contrast with the airflow management solutions of the prior art.

A preferred embodiment of the rotor in accordance with the present invention resides in the fact that the individual rotor elements have two functional regions, with one of these functional regions presenting a resistance to airflow, while a second functional region generates a lift in the airflow to thereby cause the rotor to rotate.

Hereby it is achieved that the rotor in accordance with the invention possesses both resistance rotor and lift rotor characteristics.

In particular, the rotor in accordance with the invention possesses characteristics of a resistance rotor in a central region around the hub and characteristics of a lift rotor in the two distal regions situated at ends opposite from each other.

A particularly preferred embodiment of the rotor in accordance with the invention is one where the inclined helical axes of the rotor elements have an inclination of approximately 2 to 20 degrees against the axis of rotation of the rotor.

Such a disposition allows to manufacture asymmetrical rotors which are, for instance, also capable of utilizing the airflow in a funnel-type manner from below, e.g. in the case of upwinds in mountainous regions.

Another preferred embodiment of the rotor in accordance with the invention is represented by a rotor where rotor elements succeeding each other in a direction of rotation are contiguous in the hub region via defined flow channels. Due to these defined flow channels, the impinging air is distributed in a spiraling manner over the individual rotor elements of the rotor and thus “relayed” from one region of the rotor element to the next one without significant turbulence. Hereby the spiraling movement of the airflows passed through is optimized even further due to less occurrence of turbulences and friction.

In another preferred embodiment the flow channels are defined in such a way as to conduct the air along the axis of rotation onto a flow resistance surface of a rotor element which is advancing in the direction of rotation of the rotor. Hereby it is achieved that the rotor rotates uniformly and without imbalances even at low wind forces.

One preferred embodiment of the present invention resides in the fact that the individual rotor elements of the rotor have lug-type lift elements at their opposite ends.

These lug-type lift elements serve to enhance the lift effect of the individual rotor elements, with the airflow bringing about an additional utilization of the wind force, even while disengaging from the rotor, by means of the lift elements.

Such lug-type lift elements are typically also cambered and/or have a wave-type configuration and/or present aerodynamically favorable surface patterning, e.g. half fish body profiles, at the windward surfaces thereof. Hereby the appearance of notable eddies and of undesirable decelerating forces on the rotor is prevented in the manner of the sharkskin effect.

In a particularly advantageous manner, the rotors in accordance with the invention may be realized integrally in manual small-series production. For industrial production, individual rotor elements are produced, e.g., by an injection molding process using suitable molds, with the single preforms then being connected to each other in the center area of the rotor to produce the finished rotor. Connecting may be carried out with the aid of screwed connections and/or bonding, for example.

It is furthermore preferred if the rotor elements are realized as cambered rotor blades.

### BRIEF DESCRIPTION OF THE DRAWINGS

Further advantages and features of the present invention become evident from the description of practical examples making reference to the drawings, wherein:

FIG. 1 is a perspective view of a rotor in accordance with the invention;

FIG. 2 is a perspective view of a rotor in accordance with the invention from an angle of view different from FIG. 1;

FIG. 3 shows a cross-sectional view along line A-A in FIG. 2;

FIG. 4 shows a preferred embodiment of a rotor in accordance with the invention;

FIG. 5 shows another preferred embodiment of the rotor in accordance with the invention;

FIG. 6 is a detail drawing in the area X in FIG. 5 in a top view with an associated cross-sectional view.

### DETAILED DESCRIPTION OF THE INVENTION

In the figures, 1 designates an example of a rotor for a vertical wind power station comprising triple-surface rotor elements 2A, 2B, 2C that are arranged around a hub region 3. The rotor elements 2A, 2B, 2C have a helical axis which, in the exemplary case, is parallel to the axis of rotation 4 of the rotor 1 and around which the rotor elements 2A, 2B, 2C are twisted in a spiraling manner. The rotor elements 2A, 2B, 2C have concave and convex surface regions smoothly merging into each other and having different radii of curvature along the helical axis.

The rotor 1 is frictionally coupled to the axis of rotation 4. As the rotor 1 is a vertical rotor for a vertical wind power station, the axis of rotation 4 is arranged in the direction of gravity during operation.

At the lower end (not shown in the figures) of the axis of rotation 4, a gearbox is provided which is connected to a generator that is equally caused to rotate by the rotation of the rotor 1 and in a manner known per se converts the rotary movement into electric power by magnetic induction. Both gearbox and suitable generators for wind power stations are well-known to the person having skill in the art.

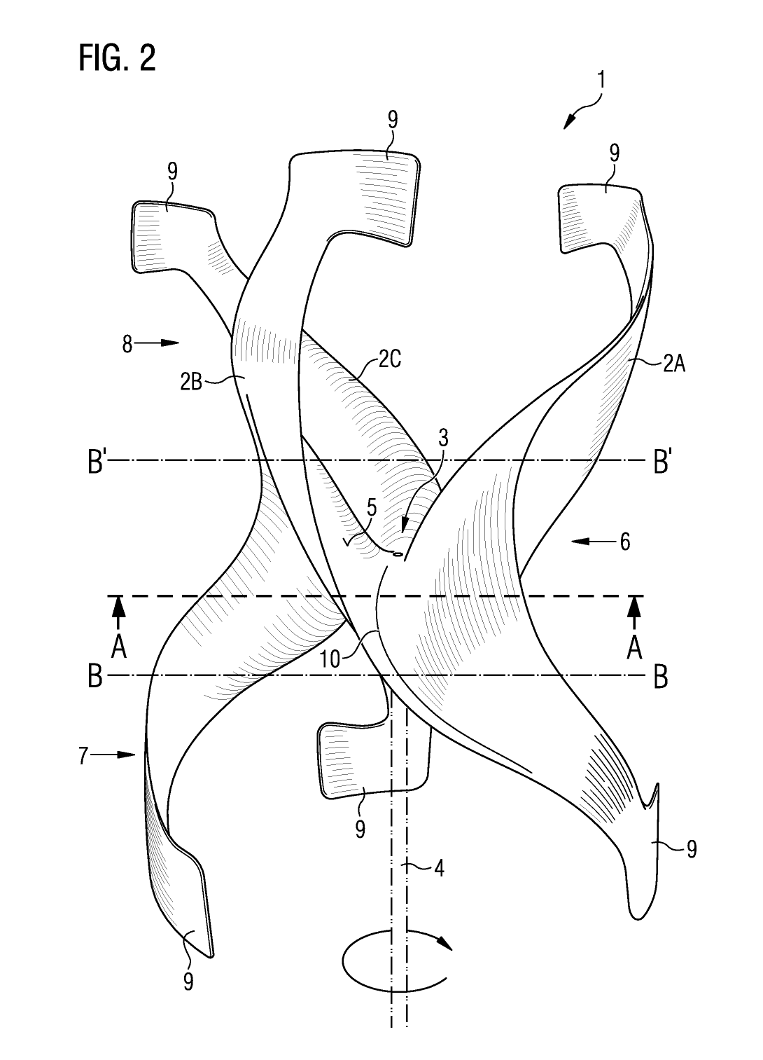

When airflow acts on the rotor, in the case of the present example, e.g. in FIG. 2 in a direction toward the paper plane, the rotor 1 rotates in the clockwise direction.

In the rotor 1, the central region 6 situated in FIG. 2 between the lines B-B and B′-B′ then operates as a functional region that poses a resistance to the airflow, and thus as a resistance rotor, while a functional region 8 situated in FIG. 2 below the line B-B and above the line B′-B′ generates a lift in the airflow and thus operates as a lift rotor.

The rotor in accordance with the invention 1 includes a central region 6 presenting the characteristics of a resistance rotor, as well as two lift regions 7 and 8 presenting the characteristics of a lift rotor.

The rotor 1 in accordance with the invention thus combines the principles of a resistance rotor with those of a lift rotor and combines the advantages of the excellent startup characteristics of a resistance rotor with the advantages provided by a lift rotor at elevated rotation speeds of the rotor 1 while at the same time presenting quiet running and low noise.

In technical and physical terms, the rotor 1 in accordance with the invention thus is understood to be a hybrid rotor.

The rotor elements 2A, 2B, 2C twisted in a spiraling manner are cambered in order to bring about the lift effect. In the central region 6 the rotor elements 2A, 2B, 2C have flow resistance surfaces 5.

In order to further enhance the lift effect of regions 7 and 8, lug-type lift elements 9 are by way of example provided on the ends of the rotor elements 2A, 2B, 2C, which enhance the lift effect and drastically reduce turbulence at the ends of the helically twisted rotor elements 2A, 2B and 2C.

In the example of FIGS. 2, 2A, and 2B, rotor elements succeeding each other in the direction of rotation additionally have defined flow channels 10 in the hub region, which are configured such as to conduct the air along the axis of rotation 4 onto a flow resistance surface of a rotor element 2A, 2B, 2C that is advancing in the direction of rotation of the rotor 1.

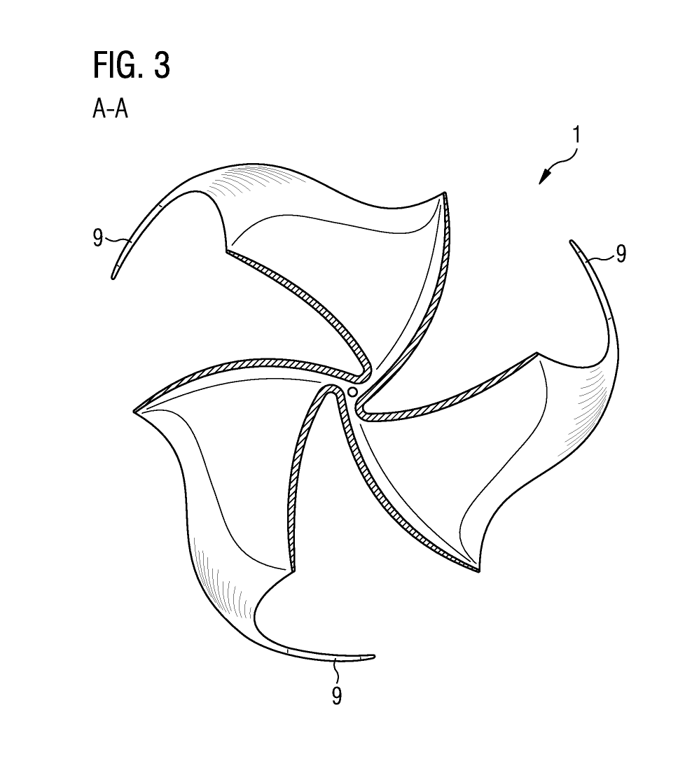

For purposes of visualization, FIG. 3 shows a cross-sectional view along line A-A in FIG. 2 in order to illustrate the arrangement of the rotor elements 2A, 2B, 2C.

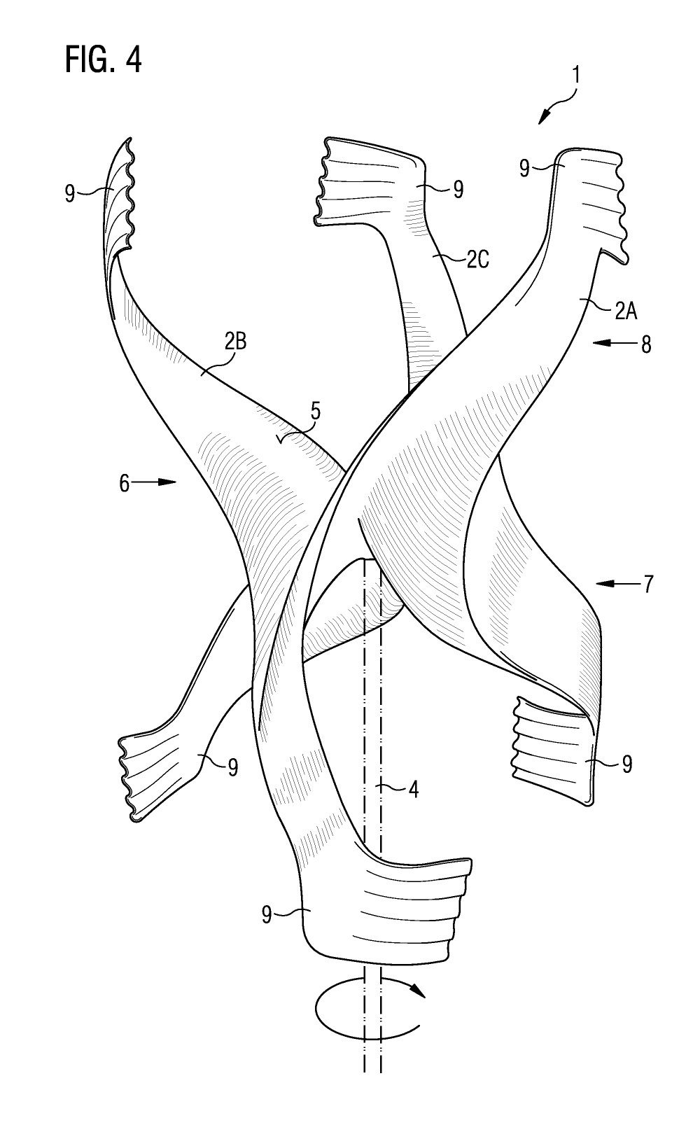

FIG. 4 shows a preferred embodiment of the rotor 1 in accordance with the invention, wherein the lug-type lift elements 9 have a wave-type configuration so as to reduce the formation of eddies.

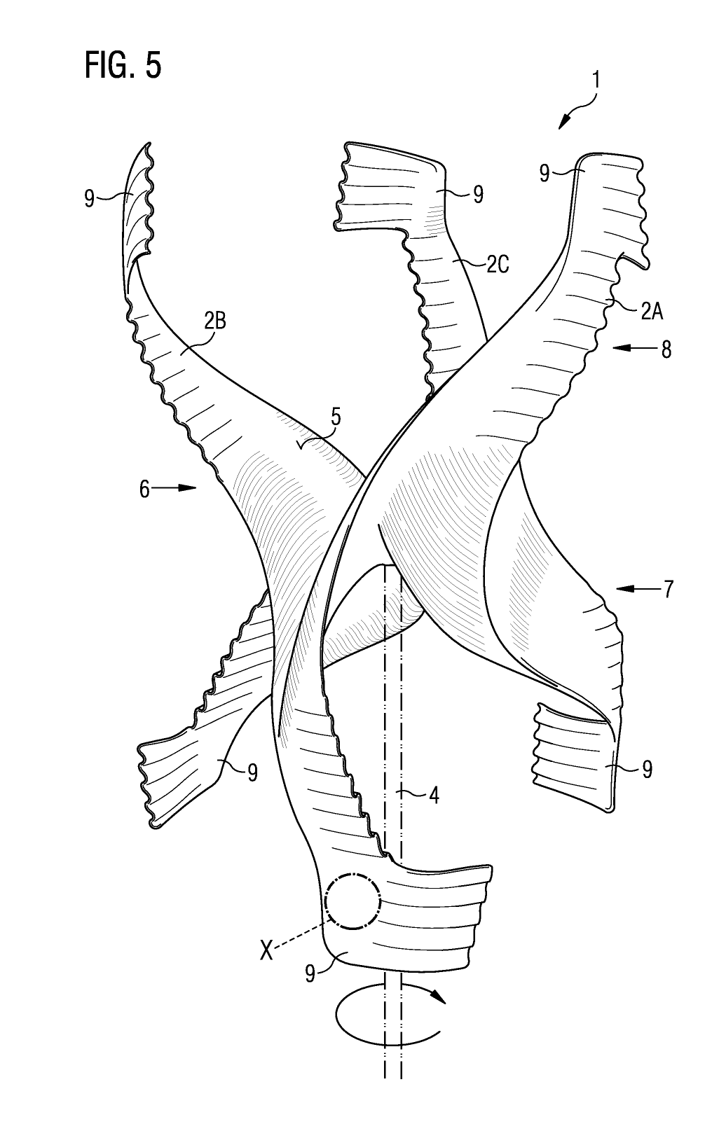

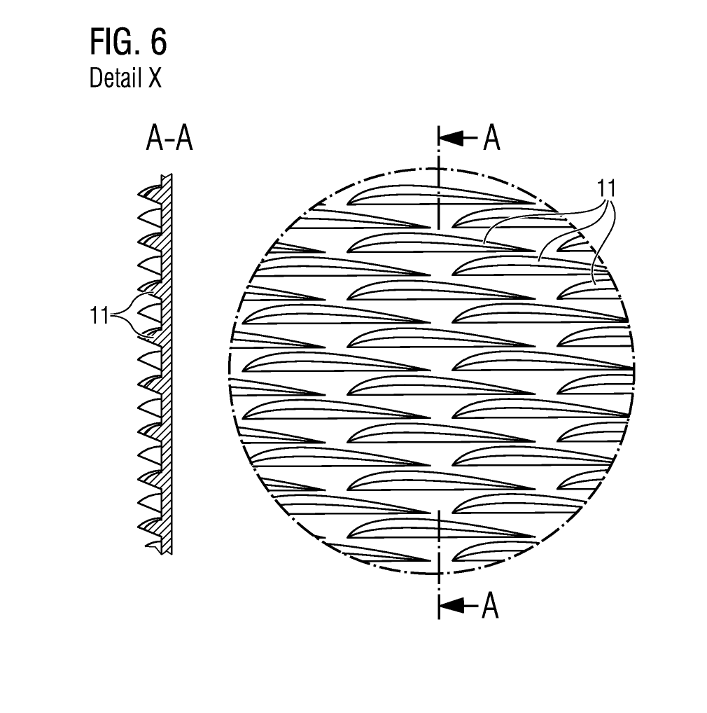

FIG. 5 shows another embodiment of a rotor 1 in accordance with the invention, wherein not only the lug-type lift elements 9 but also the lift regions 7 and 8 of the rotor have a wave-type formation. Another exemplary embodiment of the present invention is one where the lug-type lift elements 9 have a fish body profile-type surface patterning 11 on their surfaces, as is shown in FIG. 6.

This surface patterning 11 in the lift regions 7 and 8 may on the one hand be provided by itself and may on the other hand, as indicated in FIG. 5, also be provided in combination with a wave-type configuration of the lift regions 7 and 8.

Even at low wind velocities the rotor 1 in accordance with the invention allows to operate wind power stations generating 2 to 10 kW.

The rotors in accordance with the invention generate little noise and are characterized by highly smooth running and high efficiency.

The rotors in accordance with the invention may be produced of a wide variety of materials. Thus, for instance, a rotor in accordance with the invention may be produced manually by means of glass fiber-reinforced plastics. In larger series the rotors in accordance with the invention are produced by manufacturing individual rotor elements 2A, 2B, 2C through injection molding in molds and then connecting the individual rotor elements 2A, 2B, 2C to each other in the area of the hub 3 by screw connection and/or bonding.

In addition, however, exclusive light-metal constructions are conceivable which may also be produced by molding the individual rotor elements 2A, 2B, 2C. These metallic rotor elements are then screw-connected in the area of the hub 3 for manufacturing the finished rotor 1.

### LIST OF REFERENCE SYMBOLS

1: rotor
2A, 2B, 2C: rotor elements
3: hub
4: axis of rotation
5: flow resistance surface
6: central region
7: lift region
8: lift region
9: lug-type lift elements
10: flow channels
11: surface patterning

1-10. (canceled)

11. A rotor for a vertical wind power station comprising a plurality of planar rotor elements that are arranged around a hub region, characterized in that the rotor elements have a helical axis which is parallel or inclined relative to an axis of rotation of the rotor and around which the rotor elements are twisted in a spiraling manner, the rotor elements having concave and convex surface regions smoothly merging into each other and having different radii of curvature along the helical axis.

12. The rotor according to claim 11, characterized in that the individual rotor elements have two different functional regions, with one of these functional regions presenting a resistance to airflow, while a second functional region generates a lift in the airflow to thereby cause the rotor to rotate.

13. The rotor according to claim 12, characterized in that it possesses characteristics of a resistance rotor in a central region around the hub and possesses characteristics of a lift rotor in the two distal regions at ends opposite from each other.

14. The rotor according to claim 11, characterized in that the inclined helical axes of the rotor elements have an inclination of approximately 2 to 20 degrees against the axis of rotation of the rotor.

15. The rotor according to claim 11, characterized in that rotor elements succeeding each other in a direction of rotation are contiguous in the hub region via defined flow channels.

16. The rotor according to claim 15, characterized in that the flow channels are defined in such a way as to conduct the air along the axis of rotation onto a flow resistance surface of a rotor element which is advancing in the direction of rotation of the rotor.

17. The rotor according to claim 11, characterized in that the individual rotor elements have lug-type lift elements at their opposite ends.

18. The rotor according to claim 14, characterized in that partial regions of the rotor elements and the lug-type lift elements are cambered and/or have a wave-type configuration and/or are provided with aerodynamically favorable surface patterning, in particular half fish body profiles, at the windward surfaces thereof.

19. The rotor according to claim 11, characterized in that the rotor elements are realized as cambered rotor blades.

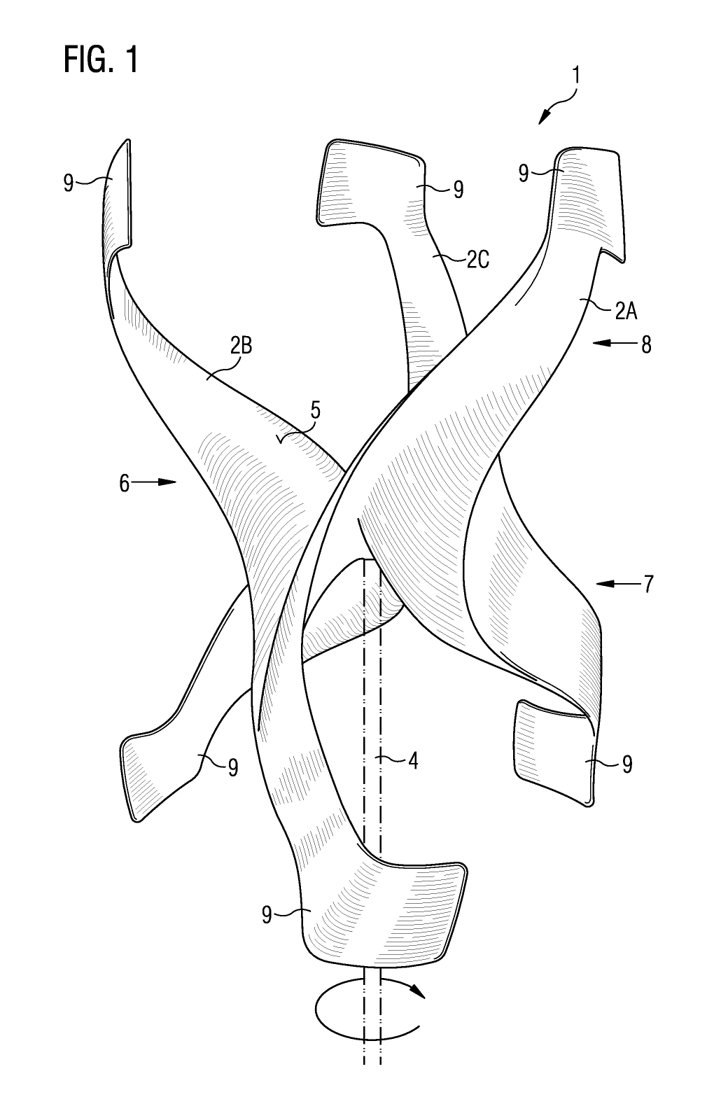

20. The rotor according to claim 11, characterized in that it is implemented in the manner substantially similar to FIG. 1.
